(19) United States
(12) Patent Application Publication
(10) Pub. No.: US 2017/0129134 A1
(43) Pub. Date: May 11, 2017

(54) BINDER AND PROCESS FOR THE ADDITIVE PRODUCTION OF MANUFACTURED ITEMS

(71) Applicant: DESAMANERA S.r.l., Rovigo (RO) (IT)

(72) Inventors: Paolo COLOMBO, Padova (PD) (IT); Alberto CONTE, Terrassa Padovana (PD) (IT); Anna DE MARZI, Arzignano (VI) (IT); Paolo SCANFERLA, Stra (VE) (IT); Antonino ITALIANO, Rovigo (RO) (IT)

(21) Appl. No.: 15/347,826

(22) Filed: Nov. 10, 2016

(30) Foreign Application Priority Data
Nov. 11, 2015 (IT) 102015000071593

(51) Int. Cl. B28B 1/00; B33Y 10/00; C04B 40/00; C04B 12/00; C04B 28/00; C04B 14/28; B33Y 70/00; B33Y 30/00

(52) U.S. Cl. CPC B28B 1/001; B33Y 70/00; B33Y 10/00; B33Y 30/00; C04B 12/005; C04B 28/006; C04B 14/28; C04B 40/0042

(57) ABSTRACT

Binder for the additive production of manufactured items, in particular made of conglomerate, adapted to be distributed on a layer of inert granular material in order to form a rigid matrix incorporating the granules of the inert granular material. The binder according to the invention is a substantially inorganic binder with geopolymer base. Another object of the invention is a process for the additive production of manufactured items by means of the use of the aforesaid binder and the use of geopolymers as binders in the additive production of manufactured items.

### FIELD OF APPLICATION

The present invention regards a binder adapted to be employed for the additive production of manufactured items, as well as a process for producing such manufactured items.

The binder and the process, object of the present invention, are inserted in the industrial field of additive production, in particular by means of 3D printing, of manufactured items preferably made of conglomerate and stone.

### STATE OF THE ART

As known, numerous processes for the additive production of manufactured items are currently available on the market, in particular by means of 3D printing machines.

More in detail, in recent years different processes have been implemented which allow the production by means of 3D printing of manufactured items made of conglomerate or stone.

Italian patent No. ITPI20050031, for example, describes a process for the additive production of manufactured conglomerate items which provides for the controlled depositing by means of computer, within an area delimited by containment walls, of layers of granular material alternated with layers of an organic binder. The latter is selectively sprayed on pre-selected zones of each layer of granular material in order to obtain the corresponding cross section of the final manufactured item. The organic binder used in such process is in particular an epoxy or polyurethane resin.

The main drawback of the above briefly-described lies in the use of organic binders, such as epoxy or polyurethane resins, obtained starting from raw materials which, in addition to being characterized by a high cost, have poor environmental compatibility.

A further process for the additive production of manufactured conglomerate items currently available on the market provides for the use of an inorganic air binder constituted by a specific magnesia cement, termed Sorel cement, and obtained from a first solid component in powder form with magnesic base, adapted to be dispersed in the granular material to form a mixture, and by a second liquid component, such as an aqueous magnesium chloride solution, adapted to be sprayed on the mixture in order to react with the first component and lead to the formation of a rigid matrix characterized by the presence of compounds in the MgO—MgCl₂—H₂O system.

The air binder used in the latter process of known type, nevertheless, has poor strength with prolonged water contact, such that the contexts of use of the manufactured items made therewith are strongly limited. In addition, the presence of chlorides, brought by the binder, render the manufactured items made by means of the above-described process incompatible with the steel usable, for example, for reinforcing the structures.

A further drawback is given by the fact that the manufactured items obtained with the above-described binder have in practice shown to be provided with density and with mechanical and durability properties that are not completely satisfactory.

Finally, the hardening of the aforesaid air binder can only occur of the mixture is not in continuous contact with water, requiring that the above-described process is executed with greater precaution.

### PRESENTATION OF THE INVENTION

The problem underlying the present invention is therefore that of overcoming the drawbacks manifested by the abovementioned solutions of known type, by providing a binder of inorganic nature for the additive production of manufactured items, in particular of conglomerate, which is also achieved starting from raw materials that are inexpensive and characterized by an optimal environmental compatibility.

A further object of the present invention is to provide a binder for the additive production of manufactured items, which allows making manufactured items provided with optical mechanical properties, hardness and strength properties even in contact with water. Another object of the present invention is to provide a binder for the additive production of manufactured items which can also be employed for making manufactured items adapted to remain in prolonged contact with the water or with the steel.

A further object of the present invention is to provide a process for the additive production of manufactured items which is simple and inexpensive to make and employ.

### BRIEF DESCRIPTION OF THE DRAWINGS

The technical characteristics of the invention, according to the aforesaid objects, can be clearly seen in the contents of the below-reported claims and the advantages thereof will be more evident in the following detailed description, made with reference to the enclosed drawings, which represent a merely exemplifying and non-limiting embodiment of the invention, in which:

FIG. 1 shows a schematized front view of an apparatus for making manufactured items by means of an additive process according to the present invention, in accordance with a first embodiment;

FIG. 2 shows a schematized front view of an apparatus for making manufactured items by means of an additive process according to the present invention, in accordance with a second embodiment.

### DETAILED DESCRIPTION

The binder and the process according to the present invention are intended to be advantageously employed for the additive production of manufactured items.

More in detail, the present binder and the process are adapted to be used for making manufactured items by means of 3D printing, in particular with a jetting technique, i.e. spraying (i.e. an indirect 3D printing technique), which provides that the manufactured items are made by spraying or simply depositing a binder in liquid form on a constantly renewed powder bed.

The binder according to the present invention is adapted for the additive production of manufactured items in particular made of conglomerate and for such purpose is adapted to be distributed on a layer of inert granular material, in order to form a rigid matrix incorporating the granules of the latter.

With the expression “granular material” it is intended herein to indicate any incoherent material suitable for 3D printing by means of jetting technique and for such purpose having a grain size adapted for creating a renewable powder bed, lacking significant defects and susceptible of forming a cohesive material when sprayed with a binder in liquid or semi-liquid form. Such granular material can contain different-size powder material as well as, for example, material in the form of fibers, of platelets or with other form factors. The material can have inorganic nature (e.g. powders of different rocks) or contain organic parts, as will be better specified hereinbelow.

In accordance with the idea underlying the present invention, the binder is a substantially inorganic binder with geopolymer base.

With the expression “substantially inorganic” it is herein intended to indicate that the binder is constituted by inorganic compounds, and can comprise minimum quantities of organic compounds, which however do not exceed 30% by weight of the binder overall, without departing from the protective scope defined by the present patent.

In addition with the expression “with geopolymer base” it is intended to indicate that the binder according to the invention is constituted for at least 70% by weight, and preferably for at least 90% by weight by geopolymer compounds.

The latter are materials obtained by means of a so-called geopolymerization reaction, i.e. polymerization via condensation, starting from a solid component in powder form, mainly comprising reactive aluminosilicates, but also phosphor or boron compounds, dissolved in a liquid component comprising an alkaline solution or, less frequently, acidic solution. The raw materials more commonly employed for the synthesis of geopolymers are kaolins or calcined clays or pozzolan, as well as discard materials from industrial processing, such as fly-ash from coal plants or muds from aluminum processing, or natural materials such as lava or volcanic ash. One or more of such raw materials are made to react in an alkaline solution, such as an aqueous solution containing hydroxides or alkaline silicates (e.g. sodium, potassium, cesium or rubidium) or, less frequently, in an acidic solution, such as an aqueous solution of phosphoric acid. Surprisingly, geopolymers have proven suitable for being employed as binders in the additive production of manufactured items, in particular by means of 3D printing and more precisely by means of jetting technique.

More in detail, the geopolymer mixture obtained from the combination of the solid component in powder form with the liquid component has proven surprisingly capable of ensuring a sufficient wettability relative to an inert granular material when sprayed thereon, so as to lead to the formation of very cohesive manufactured conglomerate items provided with mechanical characteristics that are comparable to and even better than the mechanical characteristics of the manufactured conglomerate items obtained via 3D printing, by means of jetting technique and employing known binders of different nature and in particular different inorganic binders, such as Sorel cement.

With respect to the other inorganic binders currently employed in the additive production of manufactured items, the binder with geopolymer base according to the present invention is capable of hardening in permanent contact with water and allows making manufactured items that can remain in permanent contact with the water. In particular, if the geopolymerization reaction correctly reaches completion, the manufactured items obtained by means of additive production via 3D printing with the use of a binder with geopolymer base according to the present invention are capable of resisting in contact with water even at temperatures equal to or higher than the boiling temperature of the latter.

The binder with geopolymer base according to the present invention also allows obtaining manufactured items by means of additive production, in particular per 3D printing, provided with a more compact microstructure, with a smaller porosity and hence provided with greater hardness with respect to manufactured items obtained by means of the use of known inorganic binders, such as Sorel cement.

The inorganic binder according to the present invention also has considerable flexibility of use. Geopolymers, in fact, are materials characterized by an extreme composition variability and can therefore have a microstructure as well as physical, mechanical, chemical and thermal properties that are quite variable, which can be optimized as a function of the characteristics desired for the manufactured item to be achieved.

Advantageously, the raw materials constituting the geopolymer compound adapted to be employed as binder according to the present invention, i.e. in particular a first solid component and a second liquid component adapted to be mixed in order to make the geopolymer mixture as better specified hereinbelow, are selected in order to obtain a geopolymer mixture preferably having viscosity not greater than 5000 cPoise (centipoise) during the workability interval of the mixture itself, i.e. during the time interval within which the mixture is susceptible of being mixed, transferred to the spraying nozzles and deposited on the inert granular material. In addition, the raw materials are preferably selected for ensuring a workability interval of the geopolymer mixture of at least 20 minutes, during which the viscosity of the mixture remains substantially constant.

In accordance with a particularly advantageous embodiment of the binders according to the present invention, the latter are obtained starting from a first solid component in powder form comprising reactive aluminosilicates and from a second liquid component comprising an alkaline or acidic aqueous solution, where the molar ratio between the water contained in the liquid component and the oxides which come to constitute the geopolymer network (such as aluminum oxide, silicon oxide, alkaline oxides or earth alkaline oxides, or phosphor oxides) is controlled in order to optimize both the reactivity of the mixture and its rheology, i.e. in order to regulate the workability time of the mixture and its wettability with regard to the inert granular material. The reactivity of the mixture, i.e. the reaction time, in fact depends not only on the composition of the raw materials selected for the making of the geopolymer, but also on the ratio between the water and the oxides contained therein, and hence it can be controlled by adjusting the latter ratio. In particular, the ratio between the water and the alumina contained in the solid component (H₂O/Al₂O₃) is advantageously comprised between 16 and 23 and, preferably, between 17 and 20. The ratio between the water and the other oxides directly results from the above-reported value, as a function of the type of network that one wishes to form.

The geopolymer mixture according to such embodiment, in fact, in addition to being easily sprayable through the nozzles of the print head, has shown an optimal capacity to wet and impregnate the bed of granular material. The quantity of water present in the geopolymer mixture and, more in detail, the molar ratio between the water contained in the liquid component and the oxides which come to constitute the geopolymer network, i.e. in particular the alumina, determine the characteristics both of the geopolymer mixture and of the geopolymer obtained from such mixture and hence of the manufactured item made by employing such geopolymer as binder. In particular, the optimal molar ratio between the water and the alumina allows conferring rheological characteristics to the geopolymer mixture that are adapted to allow the printing in a time sufficient interval before the consolidation of the mixture.

The molar ratio between water and alumina comprised in the above-indicated interval of values allows a nearly complete geopolymerization reaction of the geopolymer mixture, allowing the obtainment of suitable mechanical strength properties of the formed manufactured item, which would be negatively conditioned by an excessive water presence, and simultaneously optimal wettability properties of the geopolymer mixture with regard to the inert granular material, allowing the suitable impregnation of the latter. A geopolymer mixture having a molar ratio between water and alumina outside the above-indicated range could in any case allow making manufactured items by means of 3D printing, allowing the consolidation of the inert granular material, although optimal results might not be ensured in terms of stability of the solid manufactured item obtained at the end of the printing process unless the solid manufactured item is subjected to an additional thermal treatment (before or during its use), during which it is heated to temperatures higher than at least 100° C. in order to facilitate the creation of stronger ceramic phases therein.

A geopolymer mixture which has proven particularly advantageous for being employed as binder according to the present invention is obtained starting from metakaolin (2Al₂O₃.SiO₂) or calcined kaolin, in particular in combination with an aqueous solution containing a silicate or an alkaline hydroxide, such as a sodium or potassium silicate or hydroxide. The aforesaid raw materials, in fact, are characterized by low costs, which thus allow limiting the production costs for the manufactured items. In addition, such raw materials, when combined with a ratio between water and alumina comprised in the above-indicated range, allow obtaining a geopolymer mixture having rheological characteristics (and hence wettability) and a reactivity (and hence a capacity of forming geopolymer compounds) that are optimal.

As specified above, geopolymers synthesized starting from different compounds lead to different structures but above all to different characteristics, such as the gel time of the geopolymer mixture. In addition to the different raw materials, the molar ratios with which the same are present determine a different behavior of the final compound. A family of geopolymers particularly adapted for being employed as binders according to the present invention is that of polysialate-siloxanes (PSS). The latter, and in particular those with sodium base, show considerable fire resistance and resistance to high temperatures in general, as well as a high force of cohesion to steel substrates.

In accordance with an advantageous embodiment, the binder according to the present invention has alkaline base, i.e. obtained by employing a second liquid component comprising an aqueous alkaline solution and comprises a retardant additive, adapted to slow the start of the geopolymerization reaction between the first solid component and the second liquid component. The retardant additive can comprise any compound or set of compounds capable of performing a retardant action of the geopolymerization reaction, thus ensuring a more durable workability, i.e. viscosity values of the geopolymer mixture substantially constant for a time interval sufficient to allow a deposition of the geopolymer mixture that is as unchanging as possible over time. A retardant additive that is adapted to be employed in the formulation of the binder according to the present invention is for example an aqueous solution of sucrose, which has the advantage of being easily found on the market and is also particularly inexpensive.

Further or different additives can be added to the liquid geopolymer mixture, such additives suitably selected as a function of the characteristics of the specific selected geopolymer mixture in order to optimize one or more of such characteristics. For example, if the selected geopolymer mixture is characterized by a low reaction speed, instead of the retardant additives as specified above, accelerant additives can be added to the same mixture. Additives can also be added having the object of modifying the rheology of the mixture, such as fluidifying additives, or the wettability with regard to the powder bed, such as surfactants, without departing from the protective scope defined by the present patent.

Also forming the object of the present invention is a process for the additive production of manufactured items, in particular by means of 3D printing with jetting technique, by making use of a binder with geopolymer base, in particular of the above-described type. The process according to the present invention comprises the operating steps as described hereinbelow.

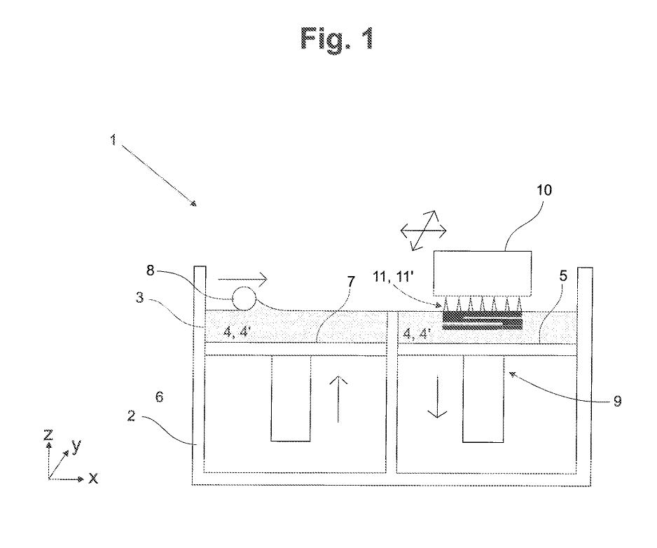

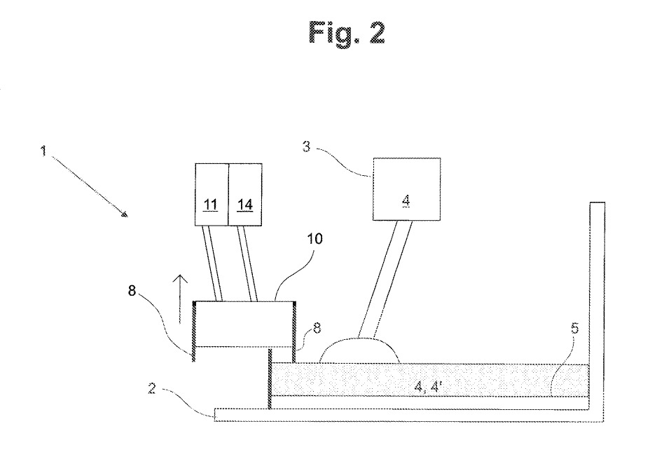

Advantageously, a step is first provided for the computer modeling of the structure of the final manufactured item that one wishes to obtain by means of the use of CAD design programs, capable of reconstructing a 3D model of the desired manufactured item. The latter is divided into successive cross sections ordered from bottom to top, delimited by planes parallel and orthogonal to the vertical, in particular equidistant from each other according to a predetermined pitch, in a manner such that such sections, printed in sequence, come to form the designed structure. Each cross section of the 3D model comprises solid and void areas, corresponding to the solid and void parts of the structure. An initial step is also advantageously provided for arranging an apparatus 1 for the 3D printing by means of jetting technique, which is schematically represented in the enclosed FIGS. 1 and 2 respectively in accordance with a first and a second possible embodiment.

The apparatus 1 comprises a support structure 2 having, associated therewith, a tank 3 for containing an inert granular material 4 or a mixture in granular form 4′ containing the inert granular material, as better explained hereinbelow. The support structure 2 also has, associated therewith, a work surface 5 adapted to receive thereon successive layers of the inert granular material 4, or of the mixture in granular form 4′, coming from the tank 3, and such layers are distributed on the work surface 5 in a controlled manner.

More in detail, in the machine in accordance with the first embodiment of FIG. 1, the tank 3 is arranged alongside the work surface 5, while in the machine in accordance with the second embodiment of FIG. 2, the tank 3 can also be arranged in a remote position with respect to the work surface 5.

The tank 3 comprises means for positioning the inert material 4, or the granular mixture 4′, towards the work surface 5.

In the first embodiment of FIG. 1, such positioning means comprise a first piston 6 adapted to lift the bottom 7 of the tank 3 along a vertical direction Z by a predefined pitch each time a new layer of inert material 4, or granular mixture 4′, must be deposited on the work surface 5, and a distribution roller 8, adapted to push and compress a predetermined quantity of inert material 4, or granular mixture 4′, towards the work surface 5 in order to deposit a layer of inert material 4, or granular mixture 4′, thereon, i.e. on the previously-deposited layers. The work surface 5 is associated with a second piston 9, adapted to lower the work surface 5 by a predefined pitch each time a new layer of inert material 4, or granular mixture 4′, must be deposited thereon.

In the second embodiment of FIG. 2, such positioning means for example comprise a duct 12 for supplying the inert material 4, or the granular mixture 4′, towards the work surface 5 and a distribution bar 13 adapted to distribute the inert material deposited by the supply duct 12 on the work surface 5.

The apparatus 1 also comprises a print head 10, adapted to selectively deposit on the work surface 5, or on each layer of inert material 4 or granular mixture 4′ deposited thereon, a component in liquid or semi-liquid form, as is better explained hereinbelow, adapted to make a rigid matrix on the bed of inert granular material 4 or granular mixture 4′ that incorporates the granules of inert material in order to define a corresponding cross section of the final manufactured item.

For such purpose, the print head 10 is moved on a plane XY parallel to the work surface 5, in particular along an axis X termed “quick axis” since it is that along which the print head 10 is moved, and along an axis Y, termed “slow axis” since it is that along which the head 5 is moved a few millimeters after having completely traveled along the axis X. In the second embodiment of FIG. 2, the work surface 5 is fixed and the print head 10 is lifted by a predefined pitch each time a new layer of inert material 4, or granular mixture 4′, must be deposited on the work surface 5. Advantageously, the distribution bar 13 for the inert material on the work surface 5 is associated with the print head 10 and is in particular arranged on the latter upstream of the spraying nozzles with respect to the advancing direction of the print head 10, as illustrated in FIG. 2, so as to level and compress the inert material 4, or the granular mixture 4′, before the second liquid component or the geopolymer mixture is released on the latter.

The process according to the present invention provides for a first step of arranging an inert granular material 4, adapted to define the aggregate of the final conglomerate with which the manufactured item is obtained. The inert granular material 4 can be selected as a function of the properties that one wishes to confer to the final manufactured item, i.e. as a function of the production or economical requirements. Inert materials that have proven particularly suitable for the production of manufactured items made of conglomerate by means of the process according to the invention are for example marble or rock powders in general, sand, and in any case even recycled materials can be used, such as bricks, tiles or plasters suitably ground or other materials that are adapted for such purpose, without departing from the protective scope defined by the present patent. The grain size of the inert material, which can be in the form of powders, of fibers, of platelets or with other form factors, as specified above, can be optimized for improving the strength of the final manufactured item and for ensuring the possibility to spread a uniform layer of powder. In addition, reinforcement materials such as fibers and minerals can be added to the inert granular material 4 in order to increase the resilience and tendency of the finished manufactured item to be isotropic, which is instead reduced due to the stratification process. Organic materials can also be added to the powder bed in order to modify and optimize some properties of the inert granular material, i.e. of the solid manufactured item obtained therewith. For example, such additions of organic material can improve properties such as the absorption of impact energy, the thermal insulation or the acoustic insulation of the manufactured items.

In particular, the inert granular material 4 (or the mixture in granular form 4′ containing the inert granular material) is arranged inside the tank 3 of the apparatus 1.

A second step is then provided for arranging a first solid component 14 in powder form, comprising reactive geopolymer precursors, such as aluminosilicates, and a second liquid component 11 comprising an alkaline or acidic aqueous solution. The first solid component 14 and the second liquid component 11 are adapted to react in order to form a binder with geopolymer base.

The second liquid component 11 (or a geopolymer mixture 11′ obtained by mixing the second liquid component with the first solid component 14, as better specified hereinbelow) is arranged inside a containment tank associated with the print head 10 of the apparatus 1. In particular, the containment tank can be arranged on the print head 10 or positioned outside the print head and be transported thereto by means of suitable ducts. The process then comprises a step of distributing, on a work surface 5, a uniform layer of predetermined thickness of the inert granular material 4 or of the mixture in granular form 4′. In particular, during such distribution step, a dose of inert granular material 4 or of the mixture in granular form 4′ is released on the work surface 5 and distributed thereon.

In accordance with the first embodiment of the machine of FIG. 1, following the elevation of the bottom 7 of the tank 3 by means of the first piston 6, the distribution roller 8 of the tank 3 pushes a predetermined quantity of inert material 4, or granular mixture 4′, towards the work surface 5 in order to create thereon, or on a previously deposited layer, the aforesaid layer of predetermined thickness.

In accordance with the second embodiment of the machine of FIG. 2, the desired dose of inert granular material 4 or of the mixture in granular form 4′ is released by the supply duct 12 on the work surface 5 and is then distributed on the latter to form a substantially uniform thickness by means of the distribution bar 13.

Subsequently, a step is provided for selective impregnation of pre-selected areas of the layer of inert granular material 4, or of the mixture in granular form 4′, and during such step of selective impregnation the second liquid component 11, or the geopolymer mixture 11′, is deposited on the aforesaid pre-selected areas of the layer of inert material, or of the mixture in granular form 4′, in order to define a corresponding cross section of a desired manufactured item, impregnating the inert granular material and forming, following the geopolymerization reaction of the first solid component in contact with the second liquid component, a rigid matrix that incorporates the granules of inert material.

In particular, during the impregnation step, the print head 10 is moved in a controlled manner, for example by means of a non-illustrated control unit, along the orthogonal axes X, Y parallel to the work surface 5, and hence to the layer of inert material 4 or of mixture in granular form 4′ deposited thereon, according to the characteristics of the structure of the manufactured item that one wishes to obtain, recorded in a computer file. The second liquid component 11, or the geopolymer mixture 11′, is then selectively released or sprayed by the print head 10 on the pre-selected areas of the layer of inert material 4 or of the mixture in granular form 4′.

The process according to the invention then provides that the step of distributing of the inert granular material 4 (or of the mixture in granular form 4′) and the step of selective impregnation of the layer thus formed with the second liquid component 11 (or with the geopolymer mixture 11′) are repeated until all the cross sections of the desired manufactured item are defined, thus obtaining a formed manufactured item.

The process according to the present invention, due to the use of the binder with geopolymer base, allows simply, quickly, automatically and inexpensively making manufactured items provided with improved mechanical properties, hardness and resistance in contact with water with respect to the manufactured items made with additive processes of known type employing inorganic air binders.

In accordance with a preferred embodiment, the process according to the present invention also comprises a step of mixing the first solid component 14, containing the reactive geopolymer precursors, with the second liquid component 11 in order to obtain a geopolymer mixture binder 11′. Such mixing step precedes the impregnation step and the latter is executed by means of the distribution of the geopolymer mixture binder on the uniform layer of inert granular material 4.

For such purpose, in particular, the first solid component and the second liquid component can be mixed outside the print head 10 and sent to the latter already mixed, or they can be mixed directly in the print head 10.

Preferably, in the present embodiment of the process according to the invention, in the distribution step only the inert granular material 4 is distributed on the work surface. Such embodiment of the process according to the invention ensures a close contact between the first solid component and the second liquid component. This facilitates a more complete geopolymerization reaction and therefore ensures the attainment of improved characteristics in the final manufactured item obtained by means of the present process.

In accordance with a variant of such preferred embodiment of the process according to the invention, the temperature of the geopolymer mixture is maintained at a temperature different from the ambient temperature, i.e. in particular different from the interval comprised between 15° C. and 20° C. For example, for a mixture with high reactivity (with quick geopolymerization reaction), such as a mixture obtained from a first component comprising reactive aluminosilicates and a second component comprising an alkaline solution, the temperature is preferably maintained in an interval between 0° C. and 10° C. and preferably between 3° C. and 6° C. For a mixture with low reactivity (with slow geopolymerization reaction), such as a mixture obtained with a second component comprising an acidic solution, the temperature is preferably maintained in the interval between 20° C. and 50° C. and preferably between 30° C. and 40° C., in order to increase the reaction speed.

Indeed, the temperature at which the geopolymerization reaction is conducted affects the course of the reaction itself, and consequently also the rheology of the solution used for printing.

The geopolymer mixture constituted by the solid component in powder form mixed with the liquid component has a non-Newtonian behavior and tends towards the gel point. The viscosity of such mixture quickly increases as the polymerization reaction progresses, such that it is difficult to ensure a sufficient work time of such mixture during which its viscosity remains nearly constant.

On such matter, it is observed that the geopolymerization reaction tends to occur more rapidly at temperatures higher than the ambient temperature. Such acceleration of the geopolymerization reaction is due to the fact that higher temperatures facilitate the formation of oligomers and hence the quick attainment of the gel point.

Therefore, in order to ensure the correct work (print) time of the geopolymer mixture, the latter is arranged at a temperature such to allow an appropriate geopolymerization reaction speed.

This ensures a constant fluidity (rheological behavior) of the geopolymer mixture for at least 20÷25 minutes following the mixing of the first solid component with the second liquid component. In accordance with the characteristics of the piece to be printed (shape, size), the stability time of the geopolymer mixture can be further varied in wide range of values (from a few minutes to several hours).

In particular the appropriate temperature of the mixture can be obtained by subjecting the mixture after its formation to cooling or heating, or by cooling or heating the second liquid component, possibly mixed with suitable additives, adapted to be mixed with the first solid component during the mixing step and then maintaining the mixture at the desired temperature.

Preferably, the stirring of the geopolymer mixture during the mixing step is protracted for a maximum time of 30 minutes, in any case suitable for ensuring an optimal level of geopolymerization of the mixture before the latter is deposited on the bed of inert granular material.

The degree of advancement of the geopolymerization reaction is in fact greater the greater the mixing time of the geopolymer mixture. This effect can be translated into a variation of the viscosity and in the anticipation of the gel point of the geopolymer mixture. The above-specified maximum stirring time allows ensuring a suitable working time, i.e. sufficiently long to allow the distribution of the geopolymer mixture on a layer of inert material in nearly-constant viscosity conditions thereof, and at the same time sufficiently reduced so to avoid extending production times. In addition, the mixing ensures that the geopolymerization reaction has reached an appropriate stage of completeness before the printing is executed. Indeed, the evaporation of the water following the printing interrupts the geopolymerization reaction and consequently the deposited binder, if not suitably pre-polymerized, would not have the desired hydraulic characteristics.

Preferably, the process according to the present invention in accordance with the above-reported preferred embodiment also comprises a step of metering a first quantity of the first solid component and a second quantity of the second liquid component which precedes the mixing step of such components. In particular, the first quantity of the first solid component and the second quantity of the second liquid component re susceptible of jointly defining substantially the exact quantity of binder necessary for impregnating the pre-selected areas of the corresponding layer of inert granular material. Additives can be added to such mixture in order to modify the characteristics thereof.

More clearly, the first solid component and the second liquid component are metered and mixed just before each step of impregnation of the layer of inert granular material 4 and in the correct quantity necessary for impregnating, only in the pre-selected areas, the corresponding layer.

This ensures the same properties of the geopolymer mixture for each impregnated layer of inert material 4, since the geopolymer mixture has a variable behavior over time.

In accordance with a different embodiment, the process according to the present invention provides that the first solid component of the binder is admixed with the inert granular material 4, instead of being mixed with the second liquid component and distributed with the latter on the bed of inert granular material 4. For such purpose, the process comprises a step of mixing the first solid reactive component with the inert granular material 4, in order to obtain a mixture in granular form 4′ adapted to be distributed on the work surface 5. The latter mixing step thus precedes the distribution step, during which the mixture in granular form 4′, comprising the first solid component and the inert granular material, is distributed on the work surface 5. The impregnation step is in such case executed by means of the distribution of only the second liquid component on the uniform layer of the mixture in granular form 4′.

The latter embodiment of the process according to the invention allows remedying the drawbacks relative to the limited work time of the geopolymer mixture, since the geopolymer reaction only occurs on the bed of granular material, following the contact of the second liquid component deposited thereon with the first solid component present in the mixture in granular form 4′.

Advantageously, the process according to the invention can comprise a step of successive thermal treatment of the formed manufactured item in order to lead to the formation of ceramic phases in the latter. Advantageously such thermal treatment can be conducted by heating the formed manufactured item to a temperature comprised between 100° C. and 1500° C. The geopolymer compounds present in the formed manufactured item, in fact, crystallize when heated, forming ceramic phases that can have high melting temperatures, even higher than 1500° C.

Such thermal treatment can also be executed during the use of the manufactured item itself, if the latter is intended to be employed at a temperature comprised in the above-reported range.

The manufactured items obtained at the end of the deposition and impregnation steps, therefore, can be simply left to rest for a suitable time period, e.g. 24 hours, in order to allow the geopolymerization reaction to be completed and the matrix thus formed to be hardened, or they can be further subjected to a thermal treatment, as a function of the characteristics sought in the final manufactured item.

Also forming the object of the present invention is the use of a geopolymer compound as binder for the additive production of manufactured items made of conglomerate by means of 3D printing, in particular by means of jetting technique.

### Embodiment

Hereinbelow, an embodiment is described relative to a binder and to a process in accordance with the present invention, and the results of the mechanical characterization tests executed on the obtained manufactured items are reported hereinbelow.

In the example reported herein, a binder was used comprising a geopolymer with empirical formula:

Rₙ[—SiO₂—AlO₂-]ₙ.wH₂O

R signifies monovalent alkali ion, such as Na⁺ and K⁺ and n degree of polymerization.

In particular, in the present embodiment it was selected to use as monovalent alkali ion that of sodium. It was in fact established that the Si—O—Al triad tends to assume a more rigid structure if a sodium ion is present rather than other monovalent cations, since Na⁺ has a smaller ionic radius and a greater charge density.

The above-reported binder was in particular obtained starting from metakaolin containing reactive aluminosilicates, as first solid component, and by an aqueous sodium silicate solution, as second liquid component.

In particular the raw materials employed for obtaining the geopolymer mixture were selected in order to have the following molar ratios:

Na₂O/SiO₂=0.263

SiO₂/Al₂O₃=3.8

Na₂O/Al₂O₃=1

for the purpose of obtaining a geopolymer structure provided with good strength and durability.

A molar ratio between water and alumina equal to 17 was also selected, since it proved optimal for the selected geopolymer in order to confer an suitable wettability of the inert granular material and an suitable reactivity of the mixture.

The second liquid component was admixed with a retardant additive, constituted by an aqueous solution of sucrose, with sucrose to water ratio of 2:1.

As inert granular material, an inert powder of “Bianco di Zandobbio”, or Dolomite was also arranged, having a grain size comprised between 0.2 mm and 1.2 mm.

The second liquid component was admixed with the first solid component at a temperature of about 4° C. and the first solid component and the second liquid component were mixed for 5 minutes. For the selected geopolymer mixture, in fact, it was possible to establish that the use of the second liquid component at the above-indicated temperature allowed extending the “useful” work time, i.e. the viscosity plateau in which it assumes a nearly constant value.

The mixture, following the mixing step, was distributed on an inert powder bed of “Bianco di Zandobbio” as specified above. The steps of mixing and distribution of the mixture on a renewed inert powder bed were repeated until all the cross sections are obtained of a substantially cubic sample, with 1.5 cm side.

Each of the samples thus obtained was subjected to compression strength tests, by using an Instron instrument with stainless steel support plates, both in transverse direction, i.e. with a direction of application of the stress substantially orthogonal to the printed layers, and in longitudinal direction, i.e. with a direction of application of the stress substantially parallel to the printed layers.

The compression strength values were derived from the application of the formula:

σ=F/A

with A intended as the area in mm² of application of the stress and F the value in Newton of maximum stress that the sample is capable of undergoing.

Reported in Table 1 hereinbelow is the data obtained from the compression strength tests on four samples obtained with the geopolymer binder, as specified above.

TABLE 1

| | | AVERAGE | ±STANDARD |
|---|---|---|---|
| | | COMPRESSION | DEVIATION |
| SAMPLE | DIRECTION | STRENGTH [MPa] | [MPa] |
| 1 | TRANSVERSE | 4.57 | 1.76 |
| | LONGITUDINAL | 17.30 | 3.35 |
| 2 | TRANSVERSE | 4.93 | 1.54 |
| | LONGITUDINAL | 16.12 | 3.97 |
| 3 | TRAVERSALE | 7.69 | 2.34 |
| | LONGITUDINAL | 11.96 | 4.88 |
| 4 | TRANSVERSE | 9.04 | 0.05 |
| | LONGITUDINAL | 20.43 | 3.05 |

The above-reported results were compared with the results obtained from compression tests executed in the same conditions on cubic samples having the same size and obtained with the same printing process, using the same inert granular material but an inorganic air binder constituted by Sorel magnesia cement rather than the geopolymer binder according to the present invention.

Reported in Table 2 reported hereinbelow is the data obtained from the compression strength tests on two samples obtained with the above-specified air binder.

TABLE 2

| | | AVERAGE | ±STANDARD |
|---|---|---|---|
| | | COMPRESSION | DEVIATION |
| SAMPLE | DIRECTION | STRENGTH [MPa] | [MPa] |
| 1a | TRANSVERSE | 1.49 | 0.27 |
| | LONGITUDINAL | 2.17 | 0.63 |
| 2a | TRANSVERSE | 1.66 | 0.13 |
| | LONGITUDINAL | 2.09 | 0.38 |

It was therefore possible to establish that the geopolymer binder is characterized by an improved compression strength with respect to an inorganic air binder of known type.

For greater clarity, the comparison between the obtained results is reported in the following Table 3.

TABLE 3

| | TRANSVERSE | | LONGITUDINAL | |
|---|---|---|---|---|
| | COMPRESSION | σ_{GEOPOLYMER} | COMPRESSION | σ_{GEOPOLYMER} |
| BINDER | STRENGTH [MPa] | σ̅_̅{̅S̅O̅R̅E̅L̅ C̅E̅M̅E̅N̅T̅}̅ | STRENGTH [MPa] | σ̅_̅{̅S̅O̅R̅E̅L̅ C̅E̅M̅E̅N̅T̅}̅ |
| Sorel Cement | 1.58 | 4.15 | 2.13 | 7.72 |
| Geopolymer | 6.56 | | 16.45 | |

Further measurements were also executed in order to evaluate the porosity of the samples obtained with the binder with geopolymer base and in order to compare the latter with the porosity of the samples obtained employing Sorel cement as binder.

The porosity, in fact, i.e. in general the ratio between the volume occupied by the pores, or voids, and the total volume of the material under examination, has an important effect in particular on the capacities of thermal and acoustic insulation, of mechanical strength and on the density of the obtained final manufactured item.

In particular, reported hereinbelow are the average open porosity values (PA) obtained for the samples with geopolymer binder and with Sorel binder, where with open porosity it is intended the scalar value or percentage that determines the presence of pores connected together or in connection with the outside environment and derived from the formula:

$$\% P A = ( 1 - \frac{{ρ}_{GEOMETRIC}}{{ρ}_{APPARENT}} ) \cdot 100$$

where ρ_{GEOMETRIC} is the density value of the material considered as the ratio between its mass, measured with balance, and its geometric volume, measured with caliper; ρ_{APPARENT} is the density value provided by a helium pycnometer using fragments of the printed samples, it is the density value obtained excluding the open porosity.

Reported in the following Table 4 is the average open porosity data, in percentage value, of the sample obtained with the geopolymer binder in accordance with the present invention, as specified above, and employing Sorel cement come binder.

TABLE 4

| BINDER | AVERAGE OPEN POROSITY [%] |
|---|---|
| Sorel cement | 43.8 |
| Geopolymer | 30.4 |

From the above-reported data, it is possible to observe that the use of a binder in accordance with the present invention allows obtaining manufactured items provided with a smaller porosity, i.e. more compact, and hence provided with improved mechanical strength and durability characteristics with respect to manufactured items obtained with known inorganic binders currently available on the market, such as Sorel cement.

The finding thus conceived therefore attains the pre-established objects.

Of course, it can assume, in the practical achievement thereof, shapes and configurations that are even different from that illustrated above, without departing from the present protective scope.

In addition, all the details can be substituted by technically equivalent elements and the size, shapes and materials used can be of any type as required.

1. Binder for the additive production of manufactured items, in particular made of conglomerate, adapted to be distributed on a layer of inert granular material in order to form a rigid matrix incorporating the granules of said inert granular material, characterized in that it is a substantially inorganic binder with geopolymer base.

2. Binder according to claim 1, characterized in that it is obtained starting from a first solid component in powder form comprising reactive aluminosilicates and from a second liquid component comprising an alkaline or acidic aqueous solution, the molar ratio between the water contained in the liquid component and the oxides contained in the first solid component and in the second liquid component, which come to constitute the geopolymer network, being controlled in order to optimize both the reactivity of the mixture and its rheology, in particular the ratio between the water and the alumina contained in the solid component (H₂O/Al₂O₃) being comprised between 16 and 23 and, preferably, between 17 and 20.

3. Binder according to claim 2, characterized in that it comprises one or more additives selected from among retardant additives, adapted to slow the start of the geopolymerization reaction between the first solid component and the second liquid component, accelerant additives, adapted to increase the reaction speed, fluidifying additives, adapted to increase the rheological characteristics of the mixture, or surfactants, adapted to improve the wettability with regard to the powder bed.

4. Process for the additive production of manufactured items by making use of a binder according to claim 1, such process comprising:
a first step of arranging an inert granular material;
a second step of arranging a first solid component in powder form, comprising reactor geopolymer precursors, and a second liquid component comprising an alkaline or acidic aqueous solution, the first solid component and the second liquid component being adapted to react to form a binder with geopolymer base;
a step of distributing, on a work surface, a uniform layer of predetermined thickness of at least said inert granular material between said inert granular material and said first solid component;
a step of selective impregnation of pre-selected areas of said layer at least with said second liquid component between said first solid component and said second liquid component in order to define a corresponding cross section of a desired manufactured item;
repeating said distribution step and said selective impregnation step until all the cross sections of the desired manufactured item have been defined, obtaining a formed manufactured item.

5. Process according to claim 4, characterized in that it also comprises a step of mixing the first solid component with the second liquid component in order to obtain a binder mixture, the impregnation step being executed by means of the distribution of the binder mixture on the uniform layer of inert granular material.

6. Process according to claim 5, characterized in that the mixture of the first solid component with the second liquid component is maintained at a different temperature from the ambient temperature and in particular at a temperature lower than the ambient temperature if the geopolymer mixture is a mixture with high reactivity and with a temperature higher than the ambient temperature if the geopolymer mixture is a mixture with low reactivity.

7. Process according to claim 5, characterized in that, during the mixing step, the stirring of the geopolymer mixture containing the first solid component and the second liquid component is protracted for a maximum time of 30 minutes and in any case suitable for ensuring an optimal level of geopolymerization of the mixture before the latter is deposited on the bed of inert granular material.

8. Process according to claim 5, characterized in that it also comprises a step of metering a first quantity of the first solid component and a second quantity of the second liquid component which precedes the step of mixing the first solid component with the second liquid component, said first quantity and said second quantity being susceptible of jointly defining the quantity of binder necessary for impregnating the pre-selected areas of the corresponding layer of inert granular material.

9. Process according to claim 5, characterized in that it also comprises a step of thermal treatment of the formed manufactured item, in order to lead to the formation of ceramic phases in the latter.

10. Use of a binder according to claim 1, comprising a geopolymer compound for the additive production of manufactured items made of conglomerate by means of 3D printing, in particular by means of jetting technique.
